(19) United States
(12) Patent Application Publication
(10) Pub. No.: US 2008/0000345 A1
(43) Pub. Date: Jan. 3, 2008

(54) Apparatus and method for interactive

(76) Inventors: Tsutomu Hasegawa, Kinnelon, NJ (US); Mami Nakamura, Kinnelon, NJ (US)

Correspondence Address: MICROWORKS CORPORATION, P.O. BOX 415, BUTLER, NJ, 07405, US

(21) Appl. No.: 11/478,063

(22) Filed: Jun. 30, 2006

(51) Int. Cl. G10H 1/38; G10H 7/00

(52) U.S. Cl. 84/613

(57) ABSTRACT

The system comprises an amplified speaker, an input sensing device, a sound synthesizer, and a programmable computer storing and executing a program containing a user input analysis algorithm, a melody composing algorithm associated with a chord supplying algorithm, and a sound conversion algorithm. Audio noises caused by tap dancing, for instance, are detected through the input sensing device and analyzed by the user input analysis algorithm. Based on the analysis result along with reference to the chord supplying algorithm, the melody composing algorithm generates a set of pitch and velocity values which is converted by the sound conversion algorithm for playback by the sound synthesizer through the amplified speaker. The entire process is carried out in real time so that each melody note newly generated is heard virtually at the same time as the original signal being input by a human performer through the input sensing device.

### CROSS-REFERENCE TO RELATED APPLICATIONS

Not Applicable

### STATEMENT REGARDING FEDERALLY SPONSORED RESEARCH OR DEVELOPMENT

Not Applicable

### STATEMENT REFERENCE TO SEQUENCE LISTING, A TABLE, OR A COMPUTER PROGRAM LISTING COMPACT DISK APPENDIX

Not Applicable

### BACKGROUND OF THE INVENTION

There have been a variety of algorithmic music composing systems introduced since the advent of personal computer. In order for taking advantage of the potentials of these systems, however, some systems require user to be familiarized with a number of user input methods unique to the systems while others require in-depth knowledge of music theory and/or training on musical instruments. Although these obstacles seem to be worthwhile to be overcome for some professionals, these difficulties may have kept novices especially children from using those inventions. If a system could instantly provide the joy of creating and performing music without requiring any of music knowledge, musical training or familiarization with the complicated system user interface, these young children could be inspired by instantly creating and performing their own music and be encouraged to learn more about music in their early age.

Another reason of this invention being introduced is based on the nature of music composing itself. As generally said, music is comprised of three elements; melody, harmony and rhythm. This, however, does not always mean that all of these three elements are required at the same time whenever composing music. For an extreme example, with an appropriate chord progression, various music compositions can be developed by altering the rhythm and melody (i.e., pitch) elements.

Most importantly, rhythm is the element that gives life to music regardless of its style, turning it into a performing art. In other words, by displaying emotions through rhythmic expressions, one can create one's own performing art and, musical performing art if some aids in terms of the harmony and pitch elements are being provided.

### BRIEF SUMMARY OF THE INVENTION

Accordingly, it is an object of the present invention to provide a real time performing technique capable of producing melody notes with startling reality by capturing emotions directly from rhythmic inputs, including input dynamics and time interval between inputs, by a human performer through an input sensing device associated with the system. Therefore, as a human performer inputs the “groove” of his or her own into the system, a melody line with the same “groove” would be produced by this system.

It is another object of the present invention to provide a music composition generating technique in such a way that pitch and velocity of melody notes automatically being determined by the system are fully based on rhythmic inputs, including input dynamics and time interval between inputs, performed by a human performer through an input sensing device associated with the system.

The system introduced by the present invention is activated solely by rhythmic inputs by a human performer through an input sensing device in order for generating melody notes and simultaneously playing the generated melody notes; eliminating the need for any of music knowledge, musical training, or familiarization with the system user interface.

Input sensing device can be any of various input devices such as microphone, pressure sensing instrument, or photocell, so long as the device is capable of providing a computer connected to with a variable signal in rapid response to the change of the degree of a physical act performed by a human performer.

As the system is turned on, a loop of a user-preselected chord progression in a memory being transposed to a user-preselected music key is automatically progressing at time intervals determined by a chord change loop algorithm in light of the psychological rhythm, or Harmonic Rhythm in musical terms, thereby, changing chords accordingly.

The user input analysis algorithm continuously scans for user input signal by a human performer through an input sensing device and, when an amount of volume of a user input signal exceeding a user-preset threshold value is being detected, determines whether accented or unaccented by referring to a record of previously detected user input signals, and transfers the result along with the volume of the detected user input signal to a melody composing algorithm.

The melody composing algorithm determines a pitch value for a new melody note to be generated from within a scale note data for a chord provided by the chord change loop algorithm at the moment of the user input signal being received, based on two elements; the accented /unaccented result determined by the user input analysis algorithm, and a record of the previously determined pitch for the previously received user input signal.

The melody composing algorithm additionally determines a velocity value for a new melody note to be generated in accordance with an amount of volume of the user input signal being received from the user input analysis algorithm, and sends a set of the determined pitch and velocity values to a sound conversion algorithm.

The sound conversion algorithm converts the received set of pitch and velocity values into the form of MIDI (Musical Instrument Digital Interface) data for a greater and flexible control over various types of sound synthesizer or DSP (Digital Signal Processor), and delivers the MIDI data to a sound synthesizer or DSP producing an audible melody note through an amplified speaker virtually at the same time as initially triggered by the human performer through the input sensing device.

The hardware (i.e., computer and synthesizer or DSP) should be capable of real time musical performance which allows the system responding immediately to a performer's actions, so that the performer hears the musical result (i.e., an audible melody note) of his or her action while the action is being made.

The system requires a multithread processing capability which allows the system playing sound data while continuously scanning for incoming user input signal.

The system additionally requires an interrupt handling capability which allows the system to interrupt the sound data currently being played back and, immediately to switch to playing back a newly generated sound data upon a new user input signal being received by the melody composing algorithm from the user input analysis algorithm.

The system further requires a very fast processing capability which allows the system to process all the functions explained from user input signal scanning down to sound conversion in a matter of mili seconds, so that a newly generated melody note would be heard virtually at the same time as the original signal being input by a human performer through an input sensing device.

### BRIEF DESCRIPTION OF THE SEVERAL VIEWS OF THE DRAWING

FIG. 1 is a diagram of the system including an input sensing device (i.g., microphone), a computer, a sound synthesizer or DSP (Digital Signal Processor), an audio amplifier, and one or more speakers laid out according to this invention.

FIG. 2 is a block diagram illustrating the functions of the system.

FIG. 3 is a flow chart of the user input analysis algorithm according to this invention.

FIG. 4 is the structure of the scale note data of a sample chord according to this invention.

FIG. 5 is a flow chart of the chord change loop algorithm according to this invention.

FIG. 6 is a flow chart of the melody composing algorithm according to this invention.

### DETAILED DESCRIPTION OF THE INVENTION

A unique suffix number between 10 and 22 appearing next to each element or component in some drawings is referred to throughout the following description.

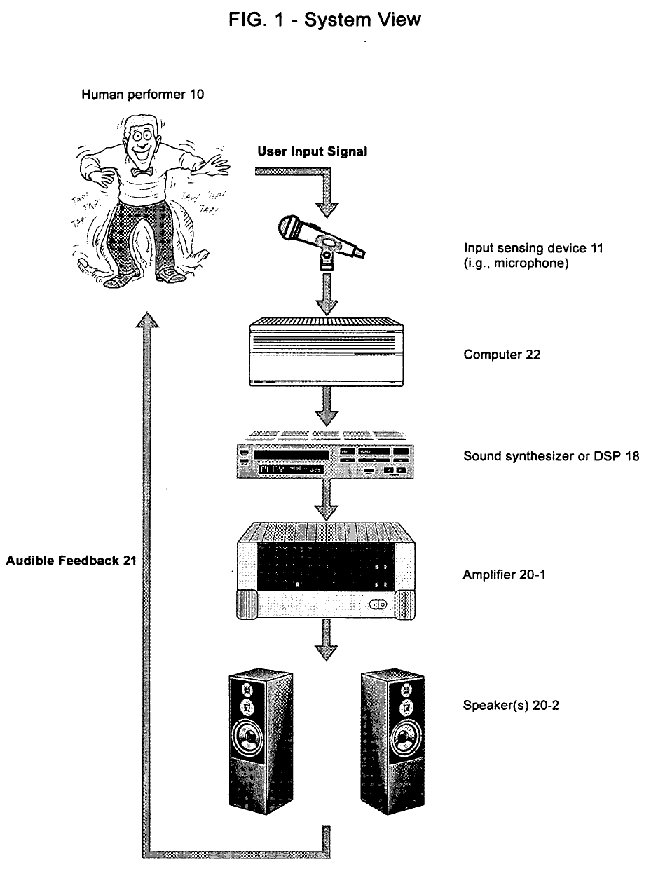

FIG. 1 illustrates the functional view of elements of this invention including an input sensing device 11 connected to a programmable computer 22 storing and executing a program containing a user interface algorithm for interpreting inputs by a human performer 10 as controls for melody composing variables, a melody composing algorithm for processing the controls for generating melody notes, and a data conversion algorithm for processing sound control data from the generated melody notes. The sound control data processed by the computer 22 are sent to a sound synthesizer or DSP (Digital Signal Processor) 18, producing audible melody notes through an amplified speaker(s) 20 or an audio amplifier 20-1 connected to one or more speakers 20-2. The input sensing device 11 can be any of various input devices such as microphone, pressure sensing instrument, or photocell, so long as the device is capable of providing the computer 22 with a variable signal in rapid response to the change of the degree of a physical act performed by a human performer 10.

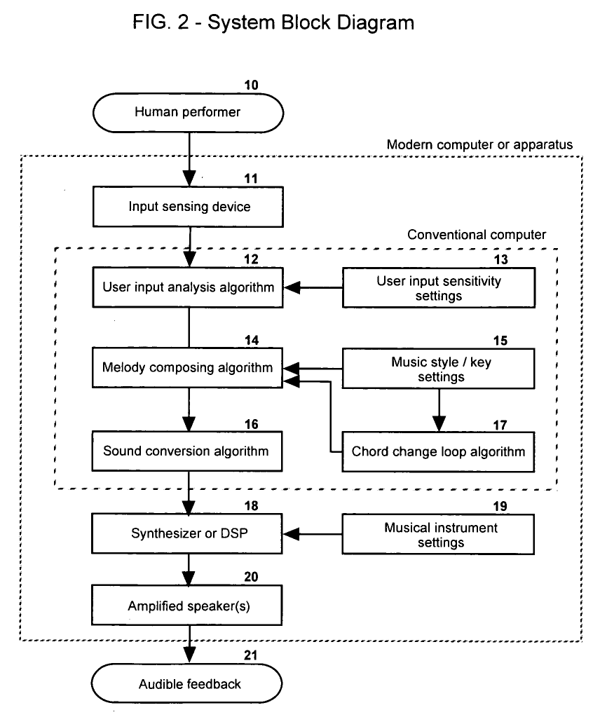

FIG. 2 schematically illustrates the functional flow of components of this invention. The system comprises an audio amplified speaker(s) 20, an input sensing device 11, a sound synthesizer or DSP (Digital Signal Processor) 18, and a programmable computer 22 storing and executing a program containing a user input analysis algorithm 12 associated with a user input sensitivity settings 13, a melody composing algorithm 14 associated with a music style/key settings 15, a chord change loop algorithm 17, and a sound conversion algorithm 16. In case of application of this invention to a modern computer or a specialized apparatus, no external or additional device including the audio amplified speaker 20, the input sensing device 11, and the sound synthesizer or DSP 18 may be required to be connected to the system. In case of application of this invention to a conventional or modern computer, user interface devices including a computer display monitor, a computer keyboard and a computer mouse may be required to be connected to the system while no such user interface device may be required in case of application of this invention to a specialized apparatus.

User input signals (i.g., audio signals) caused by the human performer 10 are continuously scanned for by the user input analysis algorithm 12 through the input sensing device 11. Upon detection of a user input signal satisfying a condition predetermined by the human performer 10 using the user input sensitivity settings 13, the user input signal is then analyzed by the user input analysis algorithm 12. Based on the analysis result, the melody composing algorithm 14 generates melody note data using scale note data provided by the chord change loop algorithm 17 at the moment the user input signal being detected. The generated melody note data is converted into a form of sound data by the sound conversion algorithm 16 for the sound synthesizer or DSP 18 to play through the amplified speaker(s) 20. The entire process is carried out in real time and virtually at the same time as the original signal being input by the human performer 10 through the input sensing device 11, allowing him or her to automatically compose and produce a melody note as audible feedback 21.

For a favorable audible feedback 21, the human performer 10 is allowed to choose one of musical instrument sounds at anytime using a sound controller when using an external sound synthesizer or DSP connected to the computer. In case of using a software sound synthesizer or DSP within a modern computer, the human performer 10 is allowed to choose one of the pre-installed musical instrument sounds at anytime using the musical instrument settings 19.

The human performer 10 is additionally allowed to choose one of fifteen music keys; C, F, B flat, E flat, A flat, D flat, G flat, C flat, G, D, A, E, B, F sharp or C sharp, at anytime using the music style/key settings 15. A value such as 1, 2 and 3 is assigned to every music key indicating a difference in the twelve musical pitch degree from the key of C to a particular music key. 0 always stands for the key of C. For example, 4 is for the key of E while 5 is for the key of F.

The human performer 10 is further allowed to choose one of the pre-installed music styles at anytime using the music style/key settings 15. The chosen music style is stored in a memory for the later use by the chord change loop algorithm 17.

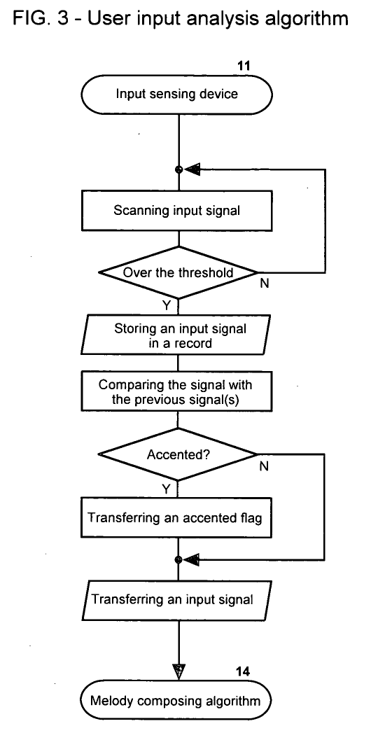

FIG. 3 is a flow chart of the user input analysis algorithm 12 of this invention. The user input analysis algorithm 12 which continuously (at a time interval of 50 mili seconds) scans for user input signals (i.g., audio signals) caused by the human performer 10 through the input sensing device 11 and, when a user input signal is detected, determines if the input value meets a threshold condition predefined by the human performer 10 using the user input sensitivity settings 13. Upon detection of a user input signal exceeding the threshold value, the detected user input signal value is stored in a record of user input signal value(s) in a memory, transferred to the melody composing algorithm 14 and, the record of user input signal value(s) is evaluated.

If no user input signal value previously stored is found in the record, no accented flag is additionally transferred to the melody composing algorithm 14. If only one user input signal value previously stored is found in the record, the current user input signal value is compared with the previously stored user input signal value and, if the current user input signal value exceeds the previously stored user input signal value, an accented flag is additionally transferred to the melody composing algorithm 14. If two user input signal values previously stored are found in the record, the current user input signal value is compared with the average value of these previously stored user input signal values and, if the current user input signal value exceeds the average value, an accented flag is additionally transferred to the melody composing algorithm 14. The oldest user input signal value in the record is discarded when the total number of user input signal value exceeds three.

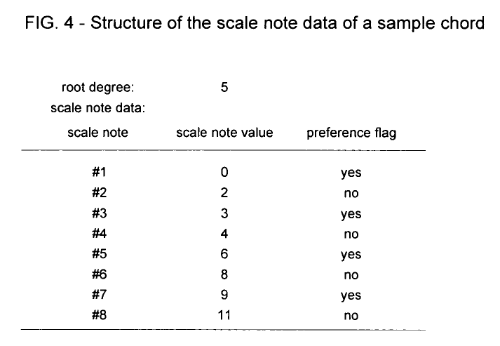

FIG. 4 illustrates the structure of a sample scale note data of this invention. A music style stored in a memory is actually a loop of a chord progression containing several chords. Each chord has data comprising of a set of the corresponding scale note data and a root degree.

A root degree represents the Roman Numeral analysis of a chord. A root degree value such as 0, 2 and 3 indicates a difference in the twelve musical pitch degree from the tonality (i.e., tonal center) of a chord progression containing a chord to the root of the particular chord. 0 always stands for the I(Roman Numeral: one) chord. For example, the root degree value for the IV(Roman Numeral: four) chord is 5 while 7 for the V(Roman Numeral: five) chord.

Depending on the quality such as diminished, dominant or major 7 of a chord being referred to, scale note data contain seven or eight values between 0 and 11 each of which is assigned to a corresponding scale note in the scale. Each scale note value indicates a difference in the twelve musical pitch degree from the root note of a scale containing a scale note to the particular scale note. 0 always stands for the scale note value of the root note. Scale note data further contain the preference flag some of which mark NO while others mark YES indicating a chord tone of the scale.

Upon a selection of a music key and a music style by the human performer 10, every scale note value in scale note data for all chords in a chord progression of the selected music style are shifted upward in the twelve musical pitch degree for the sum of two elements; a value representing the selected music key and, a root degree value defined to each chord. When the shifted scale note value exceeds 11, then the final scale note value is calculated by subtracting 12 from the shifted value. For example, the second scale note value of the IV(Roman Numeral: four) major chord in key of D is shifted from 2 to 9 (i.e., 2+5+2) while the fourth scale note value of the V(Roman Numeral: five) major chord in key of E is shifted from 5 to 16 (i.e., 5+7+4), then finally to 4 (i.e., 16−12).

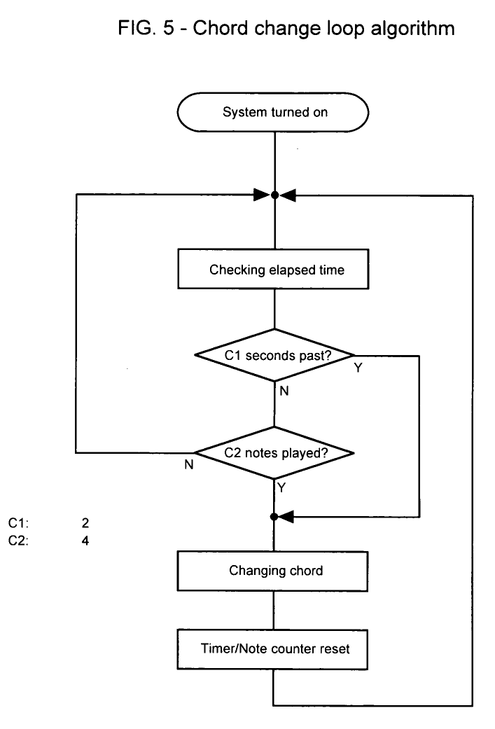

FIG. 5 is a flow chart of the chord change loop algorithm 17 of this invention. As the system is turned on, a loop of a chord progression representing the selected music style in the selected music key is automatically progressing at time intervals determined based on two psychological elements; elapsed time using a single chord and, the total number of newly generated melody notes using a single chord. The maximum elapsed time for a chord is set to 2 seconds while the maximum number of melody notes to be generated using a chord is set to 4. Regardless of either element coming first, a chord progresses to the next, changing the corresponding scale note data being referred to by the melody composing algorithm 14 and, resetting the elapsed time and the counter of melody notes being generated to 0.

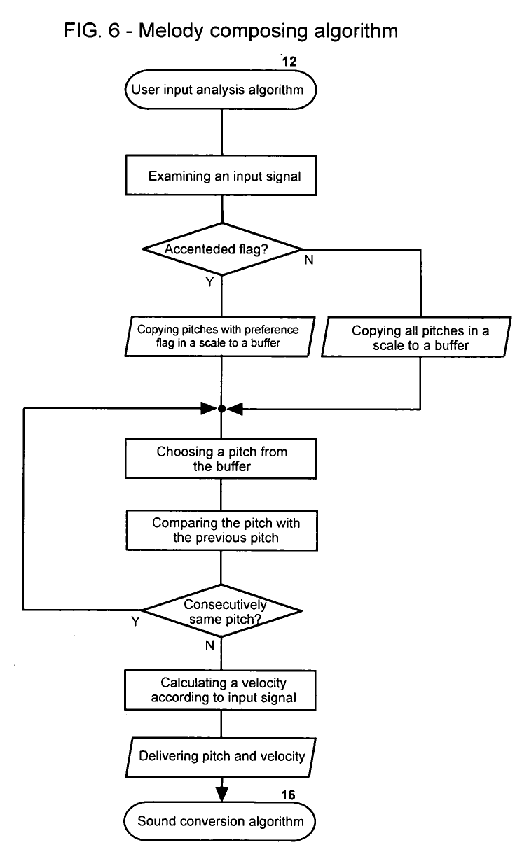

FIG. 6 is a flow chart of the melody composing algorithm 14 of this invention. Upon a user input signal being received from the user input analysis algorithm 12, the melody composing algorithm 14 first evaluates if an accented flag is associated with it. If no accented flag is found, the entire scale note values are copied to a referral memory from the scale note data currently being provided by the chord change loop algorithm 17. If an accented flag is found instead, scale note values of the preference flag marked as YES (i.e., chord tones) are selectively copied to the referral memory from the scale note data currently being provided by the chord change loop algorithm 17. The referral memory of the copied scale note values are then extended into two octaves by adding 12 to each scale note value. For example, a set of 0, 2, 3, 4, 6, 8, 9 and 11 would be extended into a set of 0, 2, 3, 4, 6, 8, 9, 11, 12, 14, 15, 16, 18, 20, 21 and 23.

Using a pseudo random number algorithm between 0 and 23, a pitch value is determined from within the set of two octave scale note values in the referral memory. This pitch determination process is, by referring to a record of the previously determined pitch value, repeated until a pitch value other than the previously determined value is being chosen. The determined pitch value is put in a record for a referral by the next pitch determination process.

Upon a user input signal being received from the user input analysis algorithm 12, a velocity value between 0.000000 and 1.000000 is determined in such a way directly proportional to the received value of the user input signal. A value of 1.000000 is assigned to a user input signal exceeding 1.000000. A set of the determined pitch and velocity values is then sent to the sound conversion algorithm 16.

In the sound conversion algorithm 16, a constant of 60 is added to the pitch value being received from the melody composing algorithm 14 so as to comfort to a practical pitch register adopted by the majority of sound synthesizer and DSP on the market.

A value between 0 and 67 is determined in such a way directly proportional to the velocity value being received from the melody composing algorithm 14. A constant of 60 is then added to the determined value so as to comfort to a practical velocity range adopted by the majority of sound synthesizers and DSP's on the market. The resultant value of either pitch or velocity, thereby, falls within 0 and 127 as defined by the MIDI (Musical Instrument Digital Interface) format for a greater and flexible control over various types of sound synthesizer and DSP.

Using a musical instrument sound chosen by the human performer 10, the sound synthesizer or DSP 18 plays and sustains a melody note of the pitch and velocity values received from the sound conversion algorithm 16 until an interruption by the sound conversion algorithm 16 responding to the next user input signal by the human performer 10 originally from the input sensing device 11 through the user input analysis algorithm 12. As the result, the sound synthesizer or DSP 18 produces audible feedback 21 through the amplified speaker(s) 20, including longer melody notes such as a whole note and shorter melody notes such as a sixteenth note all depending on time intervals between user input signals by the human performer 10 through the input sensing device 11 and the user input analysis algorithm 12.

1. An apparatus and method for interactive performing system comprising an amplified speaker; an input sensing device; a sound synthesizer or DSP (Digital Signal Processor); user interface devices including a computer display monitor, a computer keyboard and a computer mouse; and a programmable computer capable of storing and executing a program containing (1) a user input analysis algorithm associated with a user input sensitivity settings for detecting user input signal by a human performer through said input sensing device, (2) a melody composing algorithm for generating melody note data based on said user input signal detected, (3) a chord change loop algorithm associated with music style/key settings for providing said melody composing algorithm with chords, and (4) a sound conversion algorithm converting said melody note data generated into a form of sound data to be delivered to said sound synthesizer or DSP for producing audible melody notes through said amplified speaker; comprising the steps of:
several chord progressions being provided and stored in said chord change loop algorithm where a set of a root degree and scale note data being assigned accordingly to every chord in said chord progressions;
while a loop of a user-preselected chord progression in said chord change loop algorithm being transposed to a user-preselected music key automatically being progressing at time intervals determined by an internal algorithm, changing chords accordingly;
user input signal by said human performer through said input sensing device continuously being scanned by said user input analysis algorithm for detecting a meaningful user input signal which meets a predetermined condition;
said meaningful user input signal, upon detection, then being determined whether accented or unaccented based on an internal algorithm, and an amount of volume of said meaningful audio signal being transferred to said melody composing algorithm, if determined as accented, along with an accented flag;
a set of pitch and velocity values for a new melody note to be generated being determined by said melody composing algorithm in accordance with a combination of an amount of volume of said meaningful user input signal, a record of the previously determined pitch value for the previously received meaningful user input signal, said accented flag, and scale note data for a chord provided by said chord change loop algorithm at the moment said meaningful user input signal being received; and
said set of pitch and velocity values determined being sent to said sound conversion algorithm for a conversion into a form of sound data to be delivered to said sound synthesizer or DSP, producing an audible melody note through said amplified speaker virtually at the same time as initially triggered by said human performer through said input sensing device.

2. An apparatus and method for interactive performing system according to claim 1, wherein said user input analysis algorithm transfers an amount of volume of a detected user input signal to said melody composing algorithm, only when said amount of volume of said detected user input signal exceeds a threshold value preset by said human performer using said user input sensitivity settings.

3. An apparatus and method for interactive performing system according to claim 1, wherein said user input analysis algorithm additionally transfers an accented flag to said melody composing algorithm, only when said meaningful user input signal is being determined as accented in comparison with a record of meaningful user input signals previously detected.

4. An apparatus and method for interactive performing system according to claim 1, wherein said loop of a user-preselected chord progression in said chord change loop algorithm is automatically progressing at time intervals determined by a shorter time duration of; either the maximum elapsed time of two seconds using a same chord, or the maximum number of four of newly generated melody notes using a same chord.

5. An apparatus and method for interactive performing system according to claim 1, wherein said melody composing algorithm determines a pitch value for a new melody note from within said scale note data for a chord provided by said chord change loop algorithm at the moment said meaningful user input signal being received, where all members of said scale note data are being shifted upward in pitch degree for the sum of a value representing said user-preselected music key and, a value representing said root degree.

6. An apparatus and method for interactive performing system according to claim 1, wherein said melody composing algorithm further determines a pitch value for a new melody note, only when said accented flag being received, exclusively from within chord tones in said scale note data for a chord provided by said chord change loop algorithm at the moment said meaningful user input signal being received, where all members of said chord tones are being shifted upward in pitch degree for the sum of a value representing said user-preselected music key and, a value representing said root degree.

7. An apparatus and method for interactive performing system according to claim 1, wherein said melody composing algorithm determines a pitch value for a new melody note, further based on a record of the previously determined pitch value, excluding consecutively repeated assignments of a single pitch value.

8. An apparatus and method for interactive performing system according to claim 1, wherein said melody composing algorithm determines a velocity value for a new melody note in such a way directly proportional to an amount of volume of said meaningful user input signal being received from said user input analysis algorithm.

9. An apparatus and method for interactive performing system according to claim 1, wherein said sound conversion algorithm converts said set of pitch and velocity values received from said melody composing algorithm into the form of MIDI (Musical Instrument Digital Interface) data for a greater and flexible control over various types of sound synthesizer and DSP.

10. An apparatus and method for interactive performing system according to claim 1, wherein said sound synthesizer or DSP plays and sustains a new melody note of said set of pitch and velocity values in the form of MIDI received from said sound conversion algorithm until an interruption by said sound conversion algorithm responding to the next said meaningful user input signal by said human performer through said input sensing device and said user input analysis algorithm, as a whole, making said sound synthesizer or DSP produce audible feedback through said amplified speaker(s), including longer melody notes such as a whole note and shorter melody notes such as a sixteenth note all depending on time intervals between said meaningful user input signals by said human performer.

11. An apparatus and method for interactive performing system according to claim 1, wherein said input sensing device can be any of various input devices such as microphone, pressure sensing instrument, or photocell, so long as said input sensing device is capable of providing said programmable computer with a variable signal in rapid response to the change of the degree of a physical act performed by said human performer.

12. An apparatus and method for interactive performing system according to claim 1, wherein said sound synthesizer or DSP may be alternatively replaced with an identical software sound synthesizer or DSP within said program in said programmable computer in case of application of this invention to a modern computer or a specialized apparatus.

13. An apparatus and method for interactive performing system according to claim 1, wherein said amplified speaker may be alternatively replaced with a set of an audio amplifier and one or more speakers.

14. An apparatus and method for interactive performing system according to claim 1, wherein said user interface devices including a computer display monitor, a computer keyboard and a computer mouse may not be required to associated with this system in case of application of this invention to a modern computer or a specialized apparatus.
